(19) United States
(12) Patent Application Publication
(10) Pub. No.: US 2026/0340068 A1
(43) Pub. Date: Oct. 29, 2026

(54) Pattern-Lock Dark-Energy Forecast Model Cloud API and Hardware for Parameter-Free Dark-Energy Equation-of-State Evaluation Derived from Recognition-Physics Vacuum Compressibilty

(71) Applicant: Jonathan Washburn, Austin, TX (US)

(72) Inventor: Jonathan Washburn, Austin, TX (US)

(21) Appl. No.: 19/651,393

(22) Filed: Apr. 17, 2026

Related U.S. Application Data
(60) Provisional application No. 63/794,566, filed on Apr. 25, 2025.

(51) Int. Cl. G06F 17/11; G06F 9/50

(52) U.S. Cl. CPC G06F 17/11; G06F 9/5027

(57) ABSTRACT

A deterministic dark-energy forecasting framework evaluates a dark-energy equation of state as a function of cosmological scale factor without fitting free equation-of-state shape parameters. In one embodiment, a computing system receives an input corresponding to cosmological scale factor a and evaluates an equation of state according to w(a)=−1/(1+a\hat{ }(1/12)). In some embodiments, the system further evaluates a derivative of the equation of state, a dimensionless Hubble function, and one or more cosmological quantities including a comoving distance, luminosity distance, angular-diameter distance, distance modulus, or other derived observables. The framework may be implemented as local software, a network-accessible service, a batch-processing platform, or a hardware accelerator. In some embodiments, the hardware includes circuitry configured to determine a\hat{ }(1/12), compute 1+a\hat{ }(1/12), compute a reciprocal, and apply a negative sign. The framework may be integrated into survey scheduling, observatory planning, mission-design analysis, transient follow-up selection, and cosmological forecasting workflows.

### CROSS-REFERENCE TO RELATED APPLICATIONS

This application claims the benefit of U.S. Provisional Patent Application No. 63/794,566, filed on Apr. 25, 1025, the disclosure of which is incorporated herein by reference to the extent not inconsistent with the present disclosure.

### BACKGROUND OF THE INVENTION

The present disclosure relates generally to computational cosmology, dark-energy modeling, and astrophysical forecast systems, and more particularly to methods, systems, cloud services, and hardware accelerators for deterministic evaluation of a dark-energy equation of state as a function of cosmological scale factor. More specifically, the present disclosure relates to a pattern-lock dark-energy forecast framework in which an equation of state is evaluated in closed form according to w(a)=−1/(1+a\hat{ }(1/12))), together with related computations including derivative evaluation, expansion-history modeling, distance calculations, and deployment through software libraries, application programming interfaces, and accelerator hardware for use in survey planning, telescope scheduling, experiment design, and cosmological forecasting. In modern cosmology, dark energy is commonly characterized through an equation-of-state parameter w, defined as the ratio of pressure to energy density. In the standard ΛCDM framework, dark energy is modeled as a cosmological constant with w=−1. In other approaches, including widely used parameterized dark-energy models, the equation of state is treated as variable and represented using fitted parameters, such as in the Chevallier-Polarski-Linder form w(a)=w0+wa(1−a), where a is the cosmological scale factor and w0 and wa are fit to observational data. Such approaches generally require parameter estimation against supernova, baryon acoustic oscillation, cosmic microwave background, or related datasets, and often involve repeated fitting procedures, parameter sweeps, Monte Carlo marginalization, or other computationally intensive workflows.

Although conventional parameterized models are widely used, they present practical and technical limitations. In many implementations, the use of free equation-of-state parameters increases computational burden, complicates comparison across datasets, and introduces latency that can be undesirable in real-time or near-real-time applications such as survey scheduling, exposure planning, mission trade studies, automated cosmological forecast pipelines, and observatory decision-support systems. Conventional approaches may also be poorly suited for deployment in constrained computing environments, including edge systems, on-premise observatory appliances, embedded accelerators, and low-power hardware platforms, where deterministic low-latency evaluation is desirable.

Accordingly, a need exists for improved systems and methods for evaluating a dark-energy equation of state without requiring repeated fitting of free shape parameters, while still permitting efficient computation of related cosmological quantities and observables. A further need exists for implementations that can be deployed across multiple computational environments, including local scientific software, cloud-native services, batch-evaluation platforms, and hardware accelerators, while maintaining deterministic behavior, high throughput, low latency, and compatibility with survey planning and mission-analysis workflows.

The present disclosure addresses these and other technical needs by providing a deterministic, parameter-free dark-energy forecast framework based on a fixed functional relation between equation of state and scale factor, together with associated computational architectures and deployment embodiments described in greater detail below.

### SUMMARY OF THE INVENTION

The present disclosure provides systems, methods, services, and hardware implementations for deterministic evaluation of a dark-energy equation of state as a function of cosmological scale factor without fitting free equation-of-state shape parameters. In particular, the disclosed subject matter provides a pattern-lock dark-energy forecast framework in which a scale factor a is received and an equation of state is evaluated according to the fixed functional relation w(a)=−1(+a\hat{ }( 1/12)). In various embodiments, the exponent 1/12is treated as a fixed pattern-lock-derived constant rather than a fitted parameter, such that the disclosed framework avoids parameter estimation of the type commonly associated with variable equation-of-state models based on fitted w0 and wa terms.

In some embodiments, the disclosed framework further provides direct computation of one or more related quantities derived from the equation of state. Such quantities may include, by way of example and not limitation, a derivative dw/da, a dimensionless Hubble function E(a), a comoving distance, a luminosity distance, an angular-diameter distance, a distance modulus, a volume distance, a lookback-time quantity, or other cosmological observables derived in whole or in part from the evaluated equation of state. In some implementations, these computations are performed in closed form or semi-closed form. In other implementations, one or more of the computations may be performed using numerical quadrature, interpolation, lookup structures, approximation kernels, precomputed tables, surrogate evaluators, or mixed computational workflows that preserve the disclosed functional dependence of the equation of state on scale factor.

In some embodiments, the distance and observable calculator (212) accepts an input parameter that selects a distance-evaluation mode. Illustrative modes include: (i) numerical quadrature with an adaptive step size; (ii) lookup-table evaluation with interpolation between stored grid points; and (iii) a symbolic, closed-form, or semi-closed-form kernel. The calculator (212) may output metadata identifying the selected mode and, in some embodiments, an estimated numerical error bound or a status indicator associated with the selected mode.

In one aspect, the disclosure provides a computer-implemented method in which a computing device, processor system, or other evaluation engine receives one or more inputs including at least a cosmological scale factor a, evaluates w(a)=−1/(1+a\hat{ }( 1/12)), and outputs or stores a corresponding equation-of-state value. In some embodiments, the method further receives one or more cosmological context inputs, such as H0, Ω_m, Ω_DE, curvature-related inputs, radiation-related inputs, redshift values, scale-factor ranges, or combinations thereof, and computes one or more derived cosmological quantities based at least in part on the evaluated equation of state. In this manner, the disclosed methods permit deterministic evaluation of dark-energy-related forecast quantities without performing repeated parameter fitting over a variable equation-of-state shape model.

In another aspect, the disclosure provides software embodiments configured to perform the disclosed evaluations in local or distributed computational environments. In some embodiments, the disclosed subject matter is embodied as a local scientific software library, a compiled executable, a command-line tool, a notebook-integrated module, a scripting-language package, a scheduler plug-in, a mission-analysis component, or a software development kit. In some embodiments, the software may expose callable interfaces for scalar evaluation, vectorized evaluation, batch evaluation, streaming evaluation, or asynchronous workload execution, while maintaining the disclosed deterministic equation-of-state relation.

In another aspect, the disclosure provides service-based embodiments, including cloud-native and network-accessible implementations. In some embodiments, a stateless service receives requests over a network and returns evaluated equation-of-state values and/or derived cosmological quantities. In illustrative embodiments, a service may expose one or more endpoints for equation-of-state evaluation, derivative evaluation, and distance evaluation, such as an endpoint for returning w(a), an endpoint for returning dw/da, and an endpoint for returning one or more distance-related quantities based on one or more scale-factor or redshift inputs. In some embodiments, the service may further include request validation, parameter parsing, response formatting, error handling, authentication, encryption, autoscaling, telemetry, logging, health monitoring, and batch dispatch mechanisms suitable for high-throughput scientific workflows.

In another aspect, the disclosure provides hardware-accelerated embodiments for efficient evaluation of the disclosed equation-of-state relation and related calculations. In some embodiments, an accelerator subsystem includes an FPGA implementation configured to compute w(a) using a staged pipeline. In one illustrative pipeline, an input corresponding to scale factor is received, a fractional exponentiation corresponding to a\hat{ }(½) is performed, a unity-offset operation is performed, a reciprocal is computed, and a sign inversion is applied to generate the resulting equation-of-state value. In some embodiments, exponentiation may be implemented through a logarithm stage, a multiply-by- 1/12stage, and an exponential reconstruction stage. In some embodiments, reciprocal computation may be implemented through an iterative or approximate reciprocal engine, including a Newton-Raphson-based implementation. In further embodiments, arithmetic may be fixed-point, floating-point, mixed-precision, lookup-assisted, or otherwise adapted for throughput, power, precision, or deployment constraints. Although FPGA implementations are expressly contemplated, the disclosed subject matter is not limited thereto and may additionally or alternatively be implemented using GPUs, ASICs, DSPs, vector processors, CPUs, or mixed hardware/software arrangements.

In another aspect, the disclosure provides system-level embodiments that integrate the disclosed equation-of-state framework into observational, survey, and mission-planning workflows. In some embodiments, the disclosed framework is incorporated into a survey scheduler that evaluates one or more candidate observation targets, pointings, cadences, or exposure conditions using one or more outputs derived from the disclosed equation-of-state relation. In some embodiments, a scheduler may receive candidate redshifts, pointing metadata, brightness predictions, or observatory-state information and may compute one or more scores, rankings, or optimized exposure parameters using distance or expansion-history quantities derived from the disclosed framework. In some embodiments, the disclosed subject matter is integrated into mission-design workflows, including redshift-bin analysis, science-return forecasting, Fisher-matrix forecasting, observational discrimination studies, configuration trade studies, or related cosmological planning tasks.

In some embodiments, the disclosed framework is deployed in an observatory environment as a local appliance or edge system. Such an embodiment may reduce dependence on remote network connectivity and may enable low-latency or low-power evaluation in field conditions, remote installations, or constrained operational environments. In some embodiments, an observatory appliance may include one or more processors, memory resources, local storage, and a hardware accelerator configured to compute equation-of-state values and derived observables on-site for use in real-time or near-real-time observational decision support.

In certain embodiments, the disclosed subject matter further includes validation, verification, and benchmarking workflows. By way of example, the disclosed framework may be evaluated against one or more supernova datasets, baryon acoustic oscillation datasets, cosmic microwave background distance datasets, or future-survey forecast scenarios. In some embodiments, the framework may be associated with formal or semi-formal verification of one or more mathematical properties of the disclosed equation-of-state relation, such as fixed exponent support, present-day value, boundedness, monotonicity, or phantom exclusion. In some embodiments, performance benchmarking may include latency measurements, throughput measurements, capacity measurements, power measurements, or precision/error measurements for one or more software or hardware implementations.

In some embodiments, the disclosed subject matter supports multiple computational realizations while preserving the same disclosed physical relation. Thus, although certain examples herein describe direct closed-form evaluation, other embodiments may employ lookup tables, interpolation engines, polynomial or rational approximations, symbolic or compiled kernels, interval-checked evaluators, surrogate models constrained to the same base relation, or combinations thereof. Likewise, although certain examples describe inputs in terms of cosmological scale factor, additional embodiments may receive redshift, logarithmic scale parameters, reciprocal-scale representations, or other mathematically corresponding inputs from which the disclosed equation-of-state value may be determined.

Accordingly, the present disclosure provides a unified technical framework in which a fixed equation-of-state relation is used as the basis for software, service, and hardware implementations suitable for cosmological evaluation, survey planning, observatory decision support, mission design, and related scientific forecasting workflows. By replacing repeated fitting of equation-of-state shape parameters with deterministic evaluation of a disclosed functional form, the subject matter described herein can provide reduced computational overhead, improved deployment flexibility, lower latency, higher throughput, and greater suitability for integration into practical scientific and engineering systems.

### BRIEF DESCRIPTION OF THE DRAWINGS

The accompanying drawings, which are incorporated in and form a part of the specification, illustrate exemplary embodiments of the present disclosure and, together with the description, serve to explain principles of the disclosed subject matter. It will be understood that the drawings are schematic and illustrative in nature and are not necessarily drawn to scale. Reference numerals are assigned by figure series, with each figure using its corresponding hundred-series numeral and associated reference numerals within that series.

FIG. 1 is a schematic diagram of an overall system architecture for a pattern-lock dark-energy forecast system 100, showing, in one embodiment, a client device 102, a scheduler or planning engine 104, a compute service 106, an accelerator subsystem 108, a datastore 110, a network interface 112, and an observatory or mission environment 114.

FIG. 2 is a schematic diagram of an equation-of-state and cosmological computation flow 200, showing, in one embodiment, a scale-factor input 202, an exponent evaluator 204, an equation-of-state evaluator 206, a derivative evaluator 208, an expansion-history evaluator 210, a distance and observable calculator 212, an output generator 214, and a validation layer 216.

FIG. 3 is a schematic diagram of a software or API service architecture 300, showing, in one embodiment, an endpoint interface 302, a parameter parser 304, an input validator 306, a compute core 308, a batch dispatcher 310, a response formatter 312, and an authentication and monitoring module 314.

FIG. 4 is a schematic diagram of a hardware accelerator pipeline 400 for computation of the disclosed equation of state, showing, in one embodiment, an input register 402, a logarithm or exponentiation stage 404, an exponent-scale stage 406, a reconstruction stage 408, an add-one stage 410, a reciprocal stage 412, a sign inversion stage 414, and an output register 416.

FIG. 5 is a schematic diagram of a survey scheduler or mission integration workflow 500, showing, in one embodiment, a candidate input generator 502, a redshift or target estimator 504, a brightness or observable predictor 506, a distance query module 508, a scoring engine 510, an optimizer 512, a selection output 514, and an observatory or mission controller 516.

FIG. 6 is a schematic diagram of an alternative embodiments architecture 600, showing, in one embodiment, a perturbation module 602, a neutrino-mass module 604, a modified-gravity coupling module 606, a standard-siren module 608, a transient-alert module 610, an offline or on-prem deployment module 612, a model-comparison module 614, and an education or visualization module 616.

The drawings are provided to facilitate description of representative embodiments of the disclosed subject matter and are not intended to limit the scope of the invention. Additional modules, combined modules, subdivided modules, or differently arranged system components may be used in other embodiments while remaining within the scope of the present disclosure.

### DETAILED DESCRIPTION OF THE INVENTION

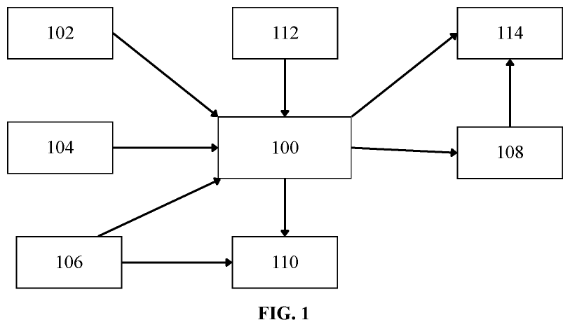

The following detailed description is provided to enable a person of ordinary skill in the art to make and use the disclosed subject matter and to set forth the best mode presently contemplated for carrying out the invention. The description is presented in the context of particular embodiments, systems, process flows, computational architectures, and hardware implementations, but these are illustrative rather than limiting. It will be understood that variations in structure, ordering, implementation, computation strategy, interface format, deployment environment, and integration pathway may be made without departing from the scope of the invention as claimed. Where appropriate, like concepts may be described with reference to one or more of FIGS. 1-6, and the disclosed figures are intended to support both standalone and combined embodiments.

In general, the disclosed subject matter provides a deterministic framework for evaluating a dark-energy equation of state as a function of cosmological scale factor and for using that evaluation in software, service, and hardware embodiments adapted for cosmological forecasting, observatory planning, survey scheduling, mission design, and related technical workflows. As shown at a system level in FIG. 1, a dark-energy forecast system 100 may include a client device 102, a scheduler or planning engine 104, a compute service 106, an accelerator subsystem 108, a datastore 110, a network interface 112, and an observatory or mission environment 114. In some embodiments, one or more of these components may be combined, omitted, virtualized, containerized, or implemented locally. For example, the compute service 106 may be a cloud-native service in some embodiments and a local workstation-resident software engine in other embodiments, while the accelerator subsystem 108 may be omitted in a purely software implementation or may be implemented as an FPGA, GPU, ASIC, DSP, vector processor, or other specialized computation resource.

For clarity of claim support and interpretation, certain variables, mathematical relations, and usage conventions are defined below. As used herein, the term “scale factor” refers to a cosmological scale factor, represented by a, and typically normalized such that a=1 at the present epoch. In many implementations, a satisfies 0<a<=1 for present-day and earlier cosmological evaluation, although the disclosed computational framework is not limited to that range unless expressly stated in a given embodiment. The term “redshift” is represented by z and may be related to scale factor according to a=1(1+z) in embodiments that accept or convert between redshift-domain and scale-factor-domain inputs. The term “equation of state” refers to a relation between effective pressure and effective energy density for a dark-energy component and is represented herein by w(a). The term “effective vacuum pressure” is represented by P_vac, the term “effective vacuum energy density” is represented by ρ_vac, and the term “vacuum compressibility function” is represented by χ(a).

As used herein, the term “parameter-free” means that the disclosed equation-of-state shape is not determined by fitting free shape parameters such as w0 and wa in a variable-parameter model. This usage does not exclude receipt of external cosmological context inputs, such as H0, Ω_m, Ω_DE, curvature-related inputs, radiation-related inputs, redshift bounds, scale-factor bounds, or observational context parameters, where such inputs are used to compute derived quantities while preserving the disclosed functional form of the equation of state. For avoidance of doubt, “parameter-free” as used herein refers to the absence of fitted equation-of-state shape parameters for w(a) (e.g., w0 and wa), and does not exclude receiving cosmological context inputs used to compute derived quantities while maintaining the disclosed functional form of w(a). As used herein, the term “closed form” means directly computable from an explicit mathematical relation without performing parameter optimization over a family of candidate equation-of-state shapes.

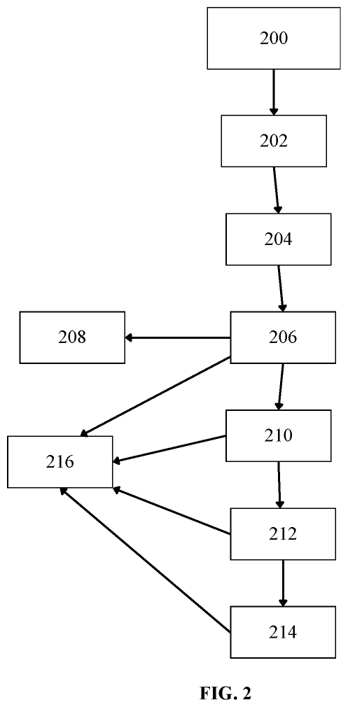

In some embodiments, a derived quantity may be computed in fully closed form, while in other embodiments a derived quantity may be computed in semi-closed form, by quadrature, by interpolation, by lookup, by precomputation, by symbolic transformation, or by another deterministic computational mechanism consistent with the disclosed base relation. In the disclosed framework, a core relation is defined between scale factor and dark-energy equation of state. As shown conceptually in the computation flow 200 of FIG. 2, a scale-factor input 202 is provided to an exponent evaluator 204, which supplies an exponentiated value to an equation-of-state evaluator 206. In one embodiment, the equation-of-state evaluator 206 computes an equation of state according to:

w(a)=−1/(1+a\hat{ }( 1/12))

In some embodiments, the exponent 1/12is treated as a fixed pattern-lock-derived exponent associated with a vacuum-compressibility framework rather than as a fitted variable. In certain theoretical embodiments, the disclosed relation may be expressed through an effective vacuum compressibility function:

χ(a)=1/(1+a\hat{ }( 1/12))

and an effective vacuum-pressure relation:

P_vac=−ρ_vac*χ(a)

such that the equation of state is given by:

w(a)=P_vac/ρ_vac=−1/(1+a\hat{ }( 1/12))

The invention is not limited to any single explanatory interpretation of why the relation takes this form, provided that the disclosed systems and methods evaluate or utilize the relation in the manner described herein.

The disclosed equation-of-state relation may be used directly or may form the basis for additional calculations. In some embodiments, the derivative evaluator 208 of FIG. 2 computes a first derivative with respect to scale factor according to:

dw/da=( 1/12)*a\hat{ }(( 1/12)−1)/(1+a\hat{ }( 1/12))\hat{ }2

This derivative may be used, for example, in sensitivity analysis, interpolation support, local approximation, expansion-history calculations, ranking logic, scheduler scoring, or validation routines. In some embodiments, additional derivatives may also be computed, including second derivatives or higher-order local approximations near selected scale-factor values, such as near a =1 or within another operational interval of interest. In certain embodiments, a validation layer 216 may compare computed values against known or expected monotonicity, bounds, or asymptotic behaviors, such as lim(a->0+)w(a)=−1 and w(1)=−½.

In some embodiments, the validation layer (216) applies one or more acceptance tests that output a pass/fail indicator. For example, the validation layer (216) may evaluate the equation-of-state value at a=1 and set a validation flag to PASS when |w(1)+0.5|≤ε, where ε is a configurable tolerance associated with a selected evaluation mode. In illustrative embodiments, ε may be selected as 1×10\hat{ }−6 for FP 32 evaluation modes, a different tolerance for FP 64 evaluation modes, and a different tolerance for fixed-point accelerator modes. The validation layer (216) may set the validation flag to FAIL when an input is outside a validated domain (e.g., a≤0), when an intermediate computation produces an error condition, or when an output falls outside an expected bound for a selected mode.

In some embodiments, an expansion-history evaluator 210 and a distance and observable calculator 212 operate on outputs of the equation-of-state evaluator 206 and, where applicable, the derivative evaluator 208. For example, a dimensionless Hubble function may be represented as:

E(a)=H(a)/H

and, in one embodiment, may be evaluated according to:

E(a)\hat{ }2=Ω_m* a\hat{ }(−3)+Ω_DE*exp(−3 *integral from 1 to a of((1+w(a′))/a′) da′)

Using such relations, the distance and observable calculator 212 may compute one or more cosmological distances. In some embodiments, a comoving distance may be computed according to:

d_C(a1, a2)=(c/H0)*integral from a1 to a2 of da/(a\hat{ }2*E(a))

From this or related quantities, the calculator 212 may additionally determine a luminosity distance, an angular-diameter distance, a distance modulus, a volume distance, a lookback-time measure, an age-related quantity, a redshift-bin observable, a baryon acoustic oscillation observable, or another cosmological forecast value. In some embodiments, one or more of these calculations may be performed directly at the calculator 212; in other embodiments, the calculator 212 may call local kernels, remote services, precomputed tables, approximation layers, or hardware-accelerated modules.

The output generator 214 may package one or more results for downstream use. In some embodiments, the output generator 214 may produce a scalar equation-of-state value, a derivative value, one or more derived observables, metadata describing the mode of computation, a validation flag, a precision indicator, a timing value, or combinations thereof. In some embodiments, such outputs are sent back to the client device 102, to the scheduler or planning engine 104, to the datastore 110, or to the observatory or mission environment 114. In some embodiments, outputs may be provided in JSON, binary serialized form, structured arrays, tabular data products, RPC payloads, local function returns, or memory-mapped register values depending on the implementation environment.

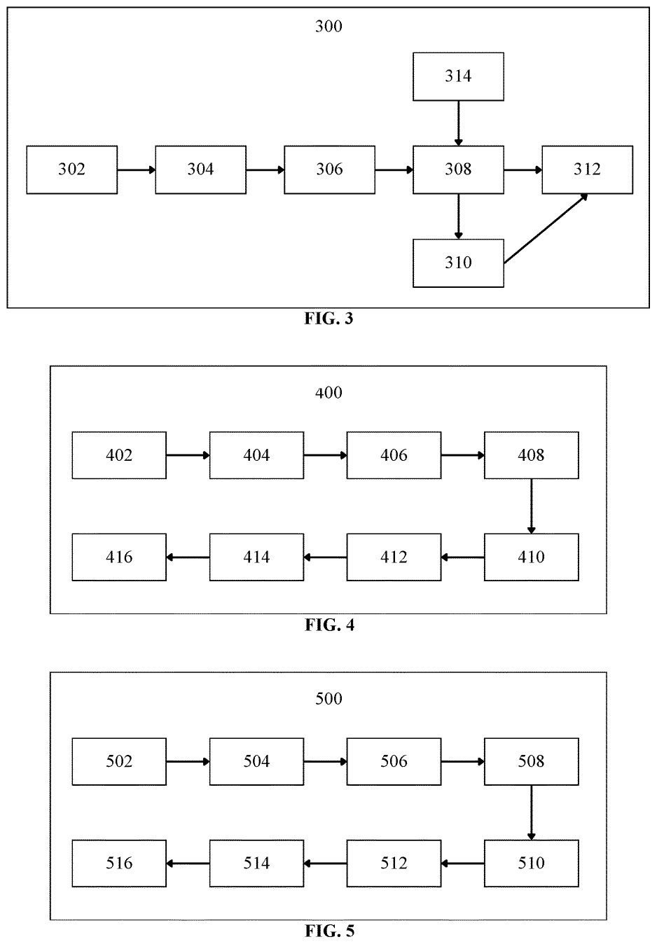

The disclosed framework may be realized in software form, service form, hardware-accelerated form, or mixed form. Referring to FIG. 3, a service architecture 300 may include an endpoint interface 302, a parameter parser 304, an input validator 306, a compute core 308, a batch dispatcher 310, a response formatter 312, and an authentication and monitoring module 314. In one embodiment, the endpoint interface 302 exposes one or more callable interfaces, such as HTTP, HTTPS, REST, gRPC, library bindings, message-bus interfaces, or other machine-readable interfaces. The parameter parser 304 may accept one or more input values including scale factor, redshift, scale-factor ranges, redshift ranges, cosmological constants, precision controls, output-format controls, or observable-selection controls. The input validator 306 may confirm that inputs are in a permitted domain, may transform between redshift and scale factor where appropriate, may reject malformed or unsupported requests, and may populate error or status fields for downstream reporting.

The compute core 308 may perform direct equation-of-state evaluation and optional derivative or observable computation using processor-executed instructions. In some embodiments, the compute core 308 may call an internal software routine. In other embodiments, the compute core 308 may dispatch a task to the accelerator subsystem 108 shown in FIG. 1. The batch dispatcher 310 may support vectorized evaluation, batch-array evaluation, large parameter sweeps over inputs other than equation-of-state shape parameters, streaming workloads, or high-throughput job handling. The response formatter 312 may package output values for return to a caller, and the authentication and monitoring module 314 may support access control, encryption, telemetry, logging, service-health status, and operational reporting.

In some embodiments, the disclosed framework is implemented in hardware or in a hardware-assisted computation pipeline. Referring to FIG. 4, an accelerator pipeline 400 may include an input register 402, a logarithm or exponentiation stage 404, an exponent-scale stage 406, a reconstruction stage 408, an add-one stage 410, a reciprocal stage 412, a sign inversion stage 414, and an output register 416. In one illustrative implementation, a scale-factor input is stored in the input register 402. The logarithm or exponentiation stage 404 may determine a logarithmic representation or otherwise begin computation of a fractional exponent. The exponent-scale stage 406 may multiply an intermediate value by 1/12 or may otherwise transform the intermediate value in a manner corresponding to the fixed disclosed exponent. The reconstruction stage 408 may reconstruct an exponentiated value corresponding to a\hat{ }( 1/12). The add-one stage 410 may compute 1+a\hat{ }( 1/12). The reciprocal stage 412 may compute the reciprocal of that value. The sign inversion stage 414 may apply a negative sign to produce w(a), and the output register 416 may store or forward the resulting output.

In some embodiments, one or more stages of the accelerator pipeline 400 may be implemented using fixed-point arithmetic. In other embodiments, floating-point arithmetic, mixed-precision arithmetic, lookup-assisted approximation, polynomial approximation, rational approximation, iterative reciprocal calculation, or segmented transformation pipelines may be used. For example, the reciprocal stage 412 may use a Newton-Raphson iteration, table-based reciprocal, or hybrid method. Likewise, the logarithm or exponentiation stage 404 and reconstruction stage 408 may be implemented using lookup tables, CORDIC-like methods, segmented approximations, direct power functions, or other circuitry or instruction sequences. The invention is not limited to a particular arithmetic implementation provided that the disclosed functional relation is computed or used.

The disclosed subject matter may also be integrated into practical planning environments. Referring to FIG. 5, an integration workflow 500 may include a candidate input generator 502, a redshift or target estimator 504, a brightness or observable predictor 506, a distance query module 508, a scoring engine 510, an optimizer 512, a selection output 514, and an observatory or mission controller 516. In one embodiment, a candidate input generator 502 may produce candidate pointings, targets, redshift intervals, observational windows, mission configurations, or experiment settings. The redshift or target estimator 504 may associate one or more redshift values, scale-factor values, or target-state variables with those candidates. The brightness or observable predictor 506 may estimate expected brightness, signal-to-noise ratio, observable sensitivity, or other forecast-relevant quantities. The distance query module 508 may obtain one or more values derived from the equation-of-state framework, such as a comoving distance, luminosity distance, distance modulus, or expansion-history quantity. The scoring engine 510 may rank or score candidate actions, and the optimizer 512 may select a preferred observational plan or mission setting. The selection output 514 may then be transmitted to an observatory or mission controller 516 for execution, storage, or review.

In some embodiments, the integration workflow 500 may be used in a survey-scheduler environment. In other embodiments, the same workflow may be adapted for mission-design, trade-study evaluation, follow-up prioritization, or observational discrimination studies. In still other embodiments, the workflow may be simplified for educational, diagnostic, or software-testing use. Although FIG. 5 shows a particular arrangement of modules, the sequence and grouping of operations may be modified in other embodiments.

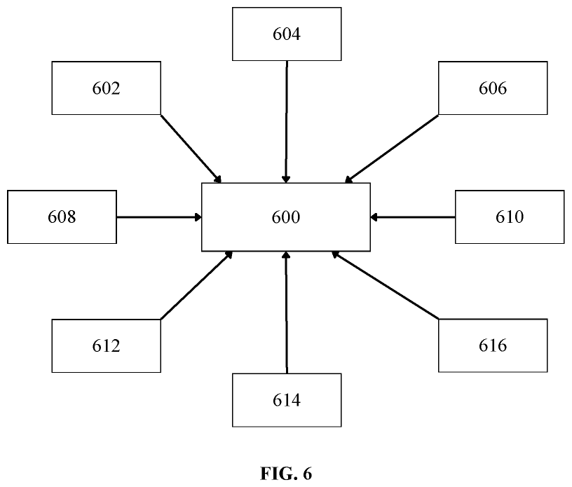

Referring to FIG. 6, the disclosed invention may further support an extension architecture 600 including a perturbation module 602, a neutrino-mass module 604, a modified-gravity coupling module 606, a standard-siren module 608, a transient-alert module 610, an offline or on-prem deployment module 612, a model-comparison module 614, and an education or visualization module 616. These modules are optional and may be omitted in core embodiments. In some embodiments, the perturbation module 602 may incorporate first-order or other perturbative extensions. The neutrino-mass module 604 may account for massive-neutrino effects in derived observable calculations. The modified-gravity coupling module 606 may permit joint use of the disclosed equation-of-state framework with an alternative gravity or growth-rate model. The standard-siren module 608 may adapt distance calculations for gravitational-wave event analysis. The transient-alert module 610 may incorporate event-triggered or follow-up scheduling logic. The offline or on-prem deployment module 612 may package the disclosed functionality for local observatory use, including environments with intermittent or absent network connectivity. The model-comparison module 614 may compare outputs of the disclosed framework to outputs from other cosmological models. The education or visualization module 616 may present results graphically or interactively for training, teaching, or outreach.

The disclosed invention is intended to support multiple computational strategies so long as the disclosed equation-of-state relation remains the operative basis of the computation. In some embodiments, equation-of-state values may be computed directly from the relation w(a)=−1/(1+a\hat{ }( 1/12)). In other embodiments, values may be obtained from one or more precomputed tables, interpolation grids, cached datasets, symbolic expressions, compiled kernels, surrogate evaluators, or hardware-resident lookup structures, provided that such techniques correspond to or preserve the disclosed relation. Similarly, derived observables may be computed by direct evaluation, semi-closed-form evaluation, numerical quadrature, adaptive quadrature, table lookup, interpolation, or combinations thereof. Such implementation flexibility is expressly contemplated to reduce the likelihood that later deployment refinements would require a continuation-in-part merely to support engineering variations of the same underlying invention.

The disclosed embodiments may also vary in precision mode. In some embodiments, computation is performed in FP64 precision. In some embodiments, FP32 precision is sufficient. In some embodiments, mixed precision may be used, such as using higher precision for selected integration steps and lower precision for repeated scalar evaluation. In some embodiments, fixed-point arithmetic may be used in an accelerator implementation to improve throughput or power efficiency. Precision-control settings may be managed, for example, by the precision controller within the compute environment or by configuration inputs supplied through the parameter parser 304, the compute core 308, or the accelerator pipeline 400. Validation logic at the validation layer 216 may optionally assess output consistency under the selected precision mode.

Although particular modules are identified in the figures, the disclosed invention is not limited to a particular module boundary or naming convention. A single processor may implement the functions of the exponent evaluator 204, equation-of-state evaluator 206, derivative evaluator 208, expansion-history evaluator 210, and distance and observable calculator 212. Likewise, a single integrated service may combine the endpoint interface 302, parameter parser 304, input validator 306, compute core 308, batch dispatcher 310, and response formatter 312. Conversely, those same functions may be distributed across separate local or networked components. Similarly, the accelerator subsystem 108 may be tightly coupled to the compute service 106, implemented as an add-in card, implemented as a network-accessible accelerator resource, or omitted.

The figures and description are intended to provide written-description support for a range of embodiments extending from a minimal local evaluator that receives a scale factor and returns w(a) to a broader system that computes derived cosmological observables and integrates such observables into survey, observatory, and mission-design workflows. Nothing in this description should be interpreted as requiring all features of all illustrated embodiments unless expressly stated in a claim. Rather, the disclosed subject matter encompasses combinations and subcombinations of the described structures, flows, modules, computations, and deployment modes.

In some embodiments, the disclosed dark-energy forecast framework operates by receiving a scale-factor input at the scale-factor input 202 of the computation flow 200 shown in FIG. 2, transforming that input at the exponent evaluator 204, and generating an equation-of-state value at the equation-of-state evaluator 206. In one embodiment, the equation-of-state evaluator 206 computes the equation of state according to the fixed relation:

w(a)=−1/(1+a\hat{ }( 1/12))

where a is cosmological scale factor. In some embodiments, a is provided directly as an input value. In other embodiments, a is derived from one or more alternate input forms, such as redshift z, logarithmic scale-factor coordinates, reciprocal scale-factor quantities, tabulated epoch identifiers, or other mathematically corresponding representations. For example, in embodiments receiving redshift, the input may be transformed according to a=1/(1+z) before evaluation at the equation-of-state evaluator 206. The invention is not limited to a particular input representation so long as the disclosed equation-of-state relation is used.

In some embodiments, the exponent evaluator 204 computes or otherwise determines the quantity a\hat{ }( 1/12). In a direct software implementation, this may be performed through a native exponentiation routine, a logarithm-and-exponential transformation, a polynomial or rational approximation, a table lookup with interpolation, or another deterministic computation strategy. In a hardware-assisted embodiment, the same value may be obtained using the accelerator pipeline 400 of FIG. 4, as described above. Once the value a\hat{ }( 1/12is obtained, the equation-of-state evaluator 206 may determine the denominator 1+a\hat{ }( 1/12), compute the reciprocal of that denominator, and apply a negative sign to produce the output w(a).

In certain theoretical embodiments, the disclosed relation may be expressed through an effective vacuum-compressibility formulation. For example, a vacuum-compressibility function may be defined as:

χ(a)=1/(1+a\hat{ }( 1/12))

and an effective vacuum-pressure relation may be defined as:

P_vac=−ρ_vac*χ(a)

so that the equation of state follows as:

w(a)=P_vac/ρ_vac=−1/(1+a\hat{ }( 1/12))

In some embodiments, this interpretation provides theoretical context for the fixed exponent and the resulting equation-of-state relation. In other embodiments, the disclosed systems and methods may practice the invention operationally without requiring any particular theory of the origin of the relation, provided that the relation itself is evaluated and used as disclosed herein.

In some embodiments, the disclosed framework uses the equation-of-state relation as a fixed, non-fitted functional form. Thus, unlike variable-parameter models that employ fitted shape parameters such as w0 and wa, the disclosed subject matter does not require optimization over a family of candidate equation-of-state shapes in order to determine w(a). Instead, the equation-of-state evaluator 206 computes w(a) deterministically from the input scale factor and the disclosed exponent relation. This fixed-form implementation can simplify execution pathways within the compute service 106, the compute core 308, the accelerator subsystem 108, and the integration workflow 500, particularly in embodiments requiring low latency, repeatability, or reduced computational overhead.

The disclosed equation-of-state relation may have one or more mathematical properties useful for implementation, verification, validation, or scientific interpretation. In some embodiments, the relation satisfies the asymptotic behavior:

lim(a->0+) w(a)=−1

which corresponds to a limiting early-scale-factor behavior. In some embodiments, at the present epoch where a=1, the relation yields:

w(1)=−1/(1+1\hat{ }(1½))=−\hat{ }1/2

In some embodiments, the disclosed framework may use this present-day value for validation, reference checking, software unit testing, hardware acceptance testing, benchmark comparisons, or output sanity checks. For example, the validation layer 216 may confirm that an evaluation performed at a=1 produces −0.5 within a defined numerical tolerance associated with a selected precision mode.

In some embodiments, the disclosed equation of state is bounded over the interval 0<a<=1 according to:

−1<w(a)<=−\hat{ }1/2

The lower bound and upper bound may be used in software assertions, range checks, hardware validation routines, and error-detection logic. In one example, the response formatter 312 or validation layer 216 may flag an error condition if an evaluated w(a) falls outside an expected interval for a selected valid input domain. In some embodiments, boundedness may also be used to size fixed-point ranges in hardware implementations, to determine clipping thresholds, or to define expected output windows for downstream planning engines.

In some embodiments, the disclosed equation of state is monotonic over an operational interval of interest. In particular, because the value a\hat{ }( 1/12) increases with increasing a for positive a, the denominator 1+a\hat{ }( 1/12) increases, and the magnitude of the negative quantity decreases, resulting in a monotonic increase of w(a) as scale factor increases. In some embodiments, this monotonic property may be used by the validation layer 216, by software-testing routines, or by interpolation logic to confirm that sampled outputs follow an expected directional trend. In some embodiments, monotonicity may also support interval compression, table generation, or reduced-complexity interpolation strategies in software or hardware lookup embodiments.

In some embodiments, the disclosed relation excludes phantom crossing over at least the interval a>0, because:

w(a)>−1

This property may be used, for example, to distinguish the disclosed framework from alternative equation-of-state models that cross or approach a phantom boundary. In some embodiments, phantom exclusion may be recorded as a validation property, a reportable model attribute, or a selectable model-comparison feature within the model-comparison module 614. In some embodiments, the derivative evaluator 208 computes a first derivative of the equation of state with respect to scale factor. In one embodiment, the first derivative is:

dw/da=( 1/12)*a\hat{ }(( 1/12)−1)/(1+a\hat{ }( 1/12))\hat{ }2

In some embodiments, the derivative evaluator 208 computes this quantity directly from the disclosed equation using symbolic, analytic, compiled, table-assisted, or numerically approximated differentiation logic. In other embodiments, the derivative may be precomputed for discrete input intervals and stored in a table or approximation structure. In still other embodiments, the derivative may be computed only when requested, such as through a derivative-specific endpoint of the endpoint interface 302, a derivative request handled by the compute core 308, or a derivative-enabled execution path of the accelerator subsystem 108. The derivative may be used in a number of ways. In some embodiments, the derivative is used in expansion-history calculations, in sensitivity analysis, in local linearization, in adaptive step-size selection, in interpolation routines, or in confidence and error estimation. In some embodiments, the derivative may be consumed by the scheduler or planning engine 104 or by the scoring engine 510 of FIG. 5 to assess the sensitivity of a forecast quantity to local changes in scale factor or redshift. In some embodiments, the derivative may be used for diagnostic purposes, such as confirming expected slope sign, checking consistency of approximate evaluators, or determining whether a selected approximation kernel remains within error tolerance across an interval.

In some embodiments, higher-order quantities may also be determined. For example, a second derivative may be derived analytically or numerically for use in curvature analysis, interpolation refinement, error bounding, or smoothness checks. In some embodiments, the compute core 308 may generate local approximations near selected operating points, such as a local series expansion about a =1, an asymptotic approximation as a->0+, or a piecewise approximation over selected subintervals. Such higher-order support is optional and need not be present in all embodiments.

The disclosed equation-of-state relation may be used as an input to a broader cosmological expansion-history calculation. In some embodiments, the expansion-history evaluator 210 computes a dimensionless Hubble function according to:

E(a)=H(a)/H0

where H(a) is the Hubble parameter and H0 is a present-day Hubble constant input. In one embodiment, the expansion-history evaluator 210 computes:

E(a)\hat{ }2=Ω_m*a\hat{ }(−3)+Ω_DE*exp(−3*integral from 1 to a of ((1+w(a′))/a′)da′)

where Ω_m and Ω_DE are cosmological density parameters received as context inputs. In some embodiments, additional terms may be included, such as curvature terms, radiation terms, neutrino-related terms, or correction terms associated with an extension module such as the neutrino-mass module 604 or modified-gravity coupling module 606. In other embodiments, a simplified form may be used where such terms are omitted.

In some embodiments, the integral within the expansion-history expression may be evaluated directly using the disclosed w(a) relation. In certain implementations, that evaluation may be performed in closed or semi-closed form. In other implementations, the evaluation may be performed using quadrature, adaptive quadrature, tabulated integral kernels, interpolation across stored values, or another deterministic method. The invention is not limited to a single integration approach. Rather, any technique may be used that produces an expansion-history value corresponding to the disclosed equation-of-state framework.

In some embodiments, the distance and observable calculator 212 computes one or more cosmological distances using the output of the expansion-history evaluator 210. In one embodiment, a comoving distance is computed according to:

d_C(a1, a2) =(c/H0) * integral from a1 to a2 of da/ (a\hat{ }2*E(a))

where c is the speed of light and a1 and a2 define an interval of interest. In some embodiments, the interval may correspond to a present-to-source interval, a source-to-source interval, a redshift-bin interval, or another domain relevant to a planning or forecast computation. In some embodiments, the comoving distance may be computed directly by the distance and observable calculator 212. In other embodiments, the calculator 212 may call one or more software kernels or hardware routines to compute or approximate the integral.

From the comoving distance, additional quantities may be determined. In some embodiments, a luminosity distance d_L may be derived from a comoving or transverse distance using a scale-factor or redshift transformation. In some embodiments, an angular-diameter distance d_A may similarly be derived. In some embodiments, a distance modulus μ may be determined from a luminosity distance or from another distance-related representation. In some embodiments, the distance and observable calculator 212 may further determine a volume distance, a baryon acoustic oscillation metric, a forecast observable for a supernova or standard-siren application, a lookback-time measure, or an age-related quantity.

In some embodiments, the distance and observable calculator 212 may support multiple evaluation modes. In a direct-evaluation mode, the calculator 212 may compute each requested quantity on demand. In a cached mode, one or more values may be looked up from precomputed tables stored locally or within the datastore 110. In an interpolation mode, values between stored grid points may be interpolated. In a batch mode, the batch dispatcher 310 may provide arrays of scale-factor or redshift inputs for simultaneous or vectorized evaluation. In a hardware-assisted mode, the accelerator subsystem 108 may compute the equation-of-state relation repeatedly while other parts of the distance computation are performed in software. In still other embodiments, a surrogate evaluator may be used so long as it remains constrained to the same disclosed relation or to derived quantities consistent therewith.

In some embodiments, representative numerical values may be used to validate implementation behavior. By way of example, evaluations may be performed at selected scale factors such as a=0.001, 0.01, 0.1, 0.3, 0.5, 0.7, and 1.0, and the corresponding values of w(a) and optionally dw/da may be checked for consistency, boundedness, and monotonicity. Such evaluations may be used in software regression tests, hardware-acceptance tests, endpoint validation, or operational calibration. In some embodiments, the validation layer 216 may compare generated values against stored reference values, analytical checks, interval bounds, or expected-ordering constraints.

In some embodiments, numerical safeguards may be applied to ensure robust operation. For example, the input validator 306 may confirm that a supplied scale factor is positive and within a selected operational range. In some embodiments, values very near zero may be clipped, rejected, transformed, or routed through a specialized evaluation pathway. In some embodiments, the reciprocal stage 412 or associated software logic may include divide-by-zero protection, saturation handling, or safe-domain enforcement. In some embodiments, derivative evaluation may use a specialized branch or tolerance-aware logic near low-scale-factor boundaries. In some embodiments, output values may be tagged with validation flags or precision indicators when reported by the response formatter 312 or output generator 214.

In some embodiments, the disclosed mathematical framework may be used both for stand-alone equation-of-state reporting and for integrated planning applications. For example, the output generator 214 may return only w(a) in a lightweight mode, may return w(a) and dw/da in a derivative mode, or may return one or more distance and forecast quantities in an observable mode. In some embodiments, these different operational modes may correspond to different endpoints of the endpoint interface 302, different API calls, different library functions, different service classes, or different execution profiles.

Accordingly, the disclosed equation-of-state relation and its derivative and observable calculations may be implemented in a variety of computational forms while preserving a common mathematical core. This provides broad written-description support for software, service, hardware, and integrated planning embodiments that share the same deterministic dark-energy equation-of-state framework.

In some embodiments, the disclosed dark-energy forecast framework is implemented as software executable on one or more general-purpose or specialized computing systems. As shown in FIG. 1, the dark-energy forecast system 100 may include a client device 102, a scheduler or planning engine 104, a compute service 106, an accelerator subsystem 108, a datastore 110, a network interface 112, and an observatory or mission environment 114. In a software-centric embodiment, the compute service 106 may be implemented as one or more software processes executing on a workstation, server, virtual machine, container, cluster node, or scientific computing environment. In a service-oriented embodiment, the compute service 106 may be exposed over a network through the network interface 112 for use by remote applications, mission-planning tools, observatory systems, or scientific analysis pipelines. In a local embodiment, the compute service 106 may be instantiated on the same machine as the client device 102 or the scheduler or planning engine 104, thereby eliminating a requirement for remote network access.

Referring to FIG. 3, a service architecture 300 may include an endpoint interface 302, a parameter parser 304, an input validator 306, a compute core 308, a batch dispatcher 310, a response formatter 312, and an authentication and monitoring module 314. These modules may be implemented in software, firmware, hardware-assisted software, or combinations thereof. In some embodiments, two or more of the illustrated modules may be combined into a single software service or executable component. In other embodiments, one or more modules may be separated into independent microservices or processing stages. The specific logical separation shown in FIG. 3 is therefore illustrative rather than limiting.

In some embodiments, the endpoint interface 302 provides one or more callable interfaces through which a requesting system can submit computation requests and receive results. By way of example, the endpoint interface 302 may support an HTTP or HTTPS interface, a REST interface, a gRPC interface, a remote procedure call interface, a command-line interface, a local function-call interface, a library API, a notebook-accessible interface, a message-queue interface, a publish-subscribe interface, or a socket-based interface. In some embodiments, the endpoint interface 302 may expose one or more functionally differentiated routes or methods corresponding to a lightweight equation-of-state evaluation, a derivative evaluation, a distance evaluation, a batch-evaluation mode, or an extended-observable mode. Although certain illustrative embodiments may refer to endpoints such as/w, /dw, and/distance, the invention is not limited to those route names or to any specific protocol syntax.

In some embodiments, the parameter parser 304 receives one or more inputs and transforms them into an internal representation suitable for processing by the compute core 308. Such inputs may include a scale factor a, a redshift z, one or more scale-factor or redshift bounds, a present Hubble constant H0, one or more density parameters such as Ω_m or Ω_DE, curvature-related terms, radiation-related terms, precision settings, output-format selections, batch arrays, job identifiers, authentication tokens, context metadata, or combinations thereof. In some embodiments, the parameter parser 304 converts redshift-domain inputs to scale-factor-domain values according to a=1/(1+z). In some embodiments, the parameter parser 304 may also normalize, rescale, reorder, or otherwise transform received values for internal computation, including transforming arrays into vectorized forms or distributing batch inputs to the batch dispatcher 310.

In some embodiments, the input validator 306 verifies that the received request is sufficiently well-formed to permit computation. The input validator 306 may confirm, for example, that a supplied scale factor is positive, that required parameters are present for requested observable calculations, that values fall within supported operational ranges, and that incompatible options are not simultaneously requested. In some embodiments, the input validator 306 may reject a request if a<=0, if mandatory cosmological context inputs are absent for a requested distance computation, if a requested precision mode is unsupported, or if a malformed data structure is received. In some embodiments, the input validator 306 may also assign defaults, such as default precision modes, default integration settings, default output formats, or default context parameters where permitted by the deployment. In some embodiments, the input validator 306 may issue a structured error indication that is ultimately packaged by the response formatter 312. In some embodiments, the compute core 308 performs the primary computational operations associated with the disclosed dark-energy framework. The compute core 308 may evaluate the equation of state w(a)=−1/(1+a\hat{ }( 1/12)), may compute the first derivative dw/da, may compute one or more expansion-history quantities, may compute one or more distance measures, or may generate one or more forecast observables. In some embodiments, the compute core 308 includes one or more software modules corresponding functionally to the exponent evaluator 204, equation-of-state evaluator 206, derivative evaluator 208, expansion-history evaluator 210, and distance and observable calculator 212 shown in FIG. 2. In some embodiments, the compute core 308 executes all such operations on a central processing unit or other programmable processor. In other embodiments, the compute core 308 may delegate one or more operations to the accelerator subsystem 108, such as dispatching repeated evaluation of a\hat{ }( 1/12) or w(a) to a hardware pipeline while retaining integral evaluation or response assembly in software. In some embodiments, the compute core 308 may operate in a scalar mode in which a single scale factor or single interval is evaluated at a time. In some embodiments, the compute core 308 may operate in a vectorized mode in which arrays of scale-factor or redshift inputs are evaluated using SIMD instructions, GPU kernels, or other parallel-processing techniques. In some embodiments, the compute core 308 may operate in a stream-processing mode in which inputs are consumed continuously or semi-continuously from a queue or data stream. In some embodiments, the compute core 308 may also support asynchronous job execution in which a request is received and acknowledged, computation is performed in the background execution environment of the service, and results are later retrieved or pushed to a requesting system. The specific execution pattern may depend on workload, deployment topology, and application context.

In some embodiments, the batch dispatcher 310 supports multi-item or high-throughput execution. For example, the batch dispatcher 310 may distribute a vector or matrix of scale-factor values across threads, cores, processes, GPUs, or hardware-accelerator resources. In some embodiments, the batch dispatcher 310 may partition a large job into smaller jobs for parallel execution and later aggregate the resulting outputs. In some embodiments, the batch dispatcher 310 may support batch requests for arrays of w(a) values, arrays of derivative values, arrays of distance values, redshift-bin sweeps, mission-study grids, or scheduler candidate sets. In some embodiments, the batch dispatcher 310 may be configured to preserve output ordering, associate outputs with request identifiers, or annotate outputs with execution metadata such as precision mode, latency, resource consumption, or validity flags.

In some embodiments, the response formatter 312 converts computation outputs into a format suitable for return to the requesting system or for storage. In some embodiments, the response formatter 312 may return a single scalar value, a structured object, an array, a table, a serialized binary payload, a protocol-buffer message, a JSON object, a CSV-like record structure, a database insertion record, or another machine-readable representation. By way of example, the response formatter 312 may return a structured response containing one or more of: an input echo, an evaluated w(a) value, an evaluated dw/da value, a distance value, a forecast-observable value, an error or status field, a validation field, a precision indicator, a units field, a timestamp, an execution identifier, or a computation-mode identifier. In some embodiments, the response formatter 312 may compress, sign, encrypt, or otherwise transform the output before delivery. In some embodiments, the authentication and monitoring module 314 provides security, observability, and operational control functions. Security functions may include user authentication, service-to-service authentication, mutual TLS, token validation, role-based access control, request signing, encrypted transport, or local authorization policy enforcement. Monitoring functions may include latency measurement, throughput measurement, request counting, error-rate measurement, resource utilization tracking, hardware-health monitoring, service-health monitoring, logging, tracing, alerting, rate limiting, or audit trail generation. In some embodiments, the authentication and monitoring module 314 may coordinate with deployment infrastructure, such as orchestration layers, autoscaling systems, local observatory management software, or network load balancers.

In some embodiments, the compute service 106 is deployed as a stateless service, meaning that request-specific state is not required to be retained between individual service invocations except where expressly configured for batching, logging, or caching. A stateless deployment can simplify scaling, load balancing, and recovery. In some embodiments, one or more instances of the compute service 106 may be replicated horizontally and placed behind a load balancer. In some embodiments, requests may be routed to any service instance capable of performing the relevant computation. In other embodiments, the compute service 106 may include stateful features, such as a cache, request history, precomputed tables, or locally retained integration kernels, without departing from the scope of the invention.

In some embodiments, the datastore 110 shown in FIG. 1 stores one or more categories of information useful for operating the disclosed framework. Such information may include precomputed values of w(a), precomputed derivative values, interpolation tables, quadrature tables, cached distance values, model-comparison datasets, scheduler inputs, mission-analysis datasets, benchmark results, hardware calibration information, service configuration values, precision-control profiles, authentication records, logs, traces, user settings, job outputs, or combinations thereof. In some embodiments, the datastore 110 may be a relational database, a key-value store, an object store, a file system, a memory cache, a scientific dataset repository, or a hybrid data layer. In some embodiments, the datastore 110 may be omitted where computation is performed entirely on demand and persistent storage is unnecessary.

In some embodiments, the network interface 112 facilitates communication among the components of the system 100 and with external systems. The network interface 112 may include one or more network adapters, controllers, protocol stacks, wireless interfaces, wired interfaces, gateway services, or edge communication modules. In some embodiments, the network interface 112 enables communication between the client device 102 and the compute service 106, between the compute service 106 and the accelerator subsystem 108, between the compute service 106 and the datastore 110, and between the scheduler or planning engine 104 and the observatory or mission environment 114. In some embodiments, communication may occur over local buses, internal interconnects, local area networks, wide area networks, satellite links, intermittent observatory links, or air-gapped data-transfer workflows.

In some embodiments, the client device 102 may be a workstation, laptop, server, cluster node, orchestration controller, mobile device, embedded controller, or another computing system capable of initiating requests and presenting or consuming results. In some embodiments, the scheduler or planning engine 104 may comprise a survey scheduler, exposure planner, target-optimization engine, mission-analysis tool, scientific workflow orchestrator, or experiment-design engine. In some embodiments, the scheduler or planning engine 104 may invoke the compute service 106 directly through the endpoint interface 302, may call a local library implementation, or may exchange data indirectly through the datastore 110. In some embodiments, the observatory or mission environment 114 may include telescope-control systems, instrument controllers, mission-analysis platforms, operator dashboards, data-ingestion systems, planning consoles, or simulation environments.

In some embodiments, the disclosed framework may be provided as a local scientific software library rather than a network service. In a library embodiment, one or more callable software functions may be linked directly into a host application. For example, a local scientific application may call a library function to compute w(a) from an input scale factor, a separate function to compute dw/da, and additional functions to compute E(a) or one or more distances. In some embodiments, the same local library may also expose vectorized or batch interfaces. In some embodiments, the local library embodiment may reduce communication overhead and simplify operation in constrained or offline environments, including observatory environments associated with the offline or on-prem deployment module 612 of FIG. 6.

In some embodiments, the disclosed framework may be provided as a software development kit or SDK. An SDK embodiment may include source code, binary code, headers, bindings, examples, configuration files, documentation, testing utilities, and deployment artifacts for use in integrating the disclosed equation-of-state engine into other applications. In some embodiments, SDKs may be provided for one or more programming languages, such as Python, Julia, C, C++, Rust, Java, Go, or another language. In some embodiments, an SDK may encapsulate communication with the compute service 106, while in other embodiments the SDK may embed local implementations of the compute core 308.

In some embodiments, the disclosed framework may support multiple response modes suited to different scientific or engineering tasks. In a lightweight response mode, the response formatter 312 may return only w(a) and optionally a minimal status field. In a derivative-enabled mode, the response formatter 312 may additionally return dw/da. In a distance mode, the response formatter 312 may return one or more of d_C, d_L, d_A, or μ. In a planning mode, the response formatter 312 may return derived metrics suitable for use by the scoring engine 510 or optimizer 512 of FIG. 5. In a benchmark or diagnostic mode, the response formatter 312 may include timing, precision, and validation metadata. These modes may be selected explicitly by request parameters, by endpoint choice, or by service configuration.

In some embodiments, request processing may include error handling and fault tolerance. For example, if the input validator 306 determines that a request is invalid, the response formatter 312 may return a structured error response without invoking the compute core 308. If the compute core 308 encounters a numerical exception, such as an unsupported domain value, an overflow condition, an unavailable hardware resource, or an integration failure, the response formatter 312 may return an error code, diagnostic message, or degraded-mode result. In some embodiments, degraded-mode execution may permit the service to continue operation using a software fallback where an accelerator resource is unavailable. In some embodiments, retry logic, timeout control, or queue backpressure may be implemented by or in coordination with the authentication and monitoring module 314.

In some embodiments, the compute service 106 may be deployed in a cloud environment. In a cloud embodiment, multiple instances of the service architecture 300 may be provisioned dynamically based on incoming workload. Autoscaling may be controlled using request rate, latency targets, resource utilization, queue depth, time of day, tenant-specific allocations, or forecasted demand. In some embodiments, the compute service 106 may be deployed in containers managed by an orchestration platform. In some embodiments, the service may use one or more GPUs or other accelerators attached to the service instances. In some embodiments, the service may be deployed across multiple availability zones or geographic regions. These cloud-specific deployment choices are optional and are included to support flexible prosecution and later implementation without limiting the invention to any one cloud platform.

In some embodiments, the compute service 106 may instead be deployed in a local or on-premise environment. For example, an observatory may host the compute service 106 on a local server connected to telescope-control systems and instrument-planning software. In some embodiments, the accelerator subsystem 108 may be co-located with the compute service 106 in an observatory rack, edge appliance, or embedded scientific compute platform. In some embodiments, local deployment may reduce latency, improve reliability under intermittent network conditions, and permit use in remote sites. Such an embodiment may coordinate with the offline or on-prem deployment module 612 of FIG. 6.

In some embodiments, the software and service embodiments may support model comparison. For example, the model-comparison module 614 may invoke the compute core 308 for the disclosed equation-of-state framework and may also invoke one or more comparison models, such as a constant-w model or another variable-w model, in order to compare outputs for a common set of scale-factor or redshift inputs. In some embodiments, such comparisons may be used for research, validation, plotting, benchmarking, observatory decision support, or mission-design trade studies. The disclosed invention is not limited to isolated use of the model and may be practiced in comparative workflows.

In some embodiments, the disclosed software and service embodiments are configured to support deterministic behavior. By deterministic behavior, it is meant that for a given set of inputs, configuration settings, and operational modes, the system returns reproducible outputs corresponding to the disclosed functional relation. This does not preclude the use of approximations, interpolation, caching, or hardware acceleration, provided that those implementations are constrained to produce outputs consistent with the disclosed model and with the tolerances selected for the relevant embodiment. Deterministic execution can be advantageous in observatory planning, mission studies, test reproducibility, hardware validation, scientific auditability, and prosecution support.

Accordingly, the disclosed software, service, and API embodiments provide a broad yet cohesive implementation framework for receiving inputs, validating those inputs, evaluating the disclosed dark-energy equation of state and related quantities, packaging and returning results, and integrating such results into scientific, observational, and engineering environments. These embodiments support local, remote, cloud, on-premise, batch, interactive, and accelerator-assisted deployments while preserving the same underlying equation-of-state relation. In some embodiments, the disclosed dark-energy forecast framework is implemented in or accelerated by dedicated hardware configured to evaluate the disclosed equation-of-state relation and, in some cases, one or more derived quantities. As shown in FIG. 1, the dark-energy forecast system 100 may include an accelerator subsystem 108 operatively coupled to the compute service 106 and, in some embodiments, to the datastore 110, the network interface 112, and the scheduler or planning engine 104. In some embodiments, the accelerator subsystem 108 is configured to offload repeated or latency-sensitive computations from a general-purpose processor. In some embodiments, the accelerator subsystem 108 may be implemented as an FPGA-based accelerator, a GPU-based accelerator, an ASIC, a DSP-based computation engine, a vector processor, a coprocessor, a smart network interface, an edge-compute module, or another hardware-assisted computation resource. Although specific examples below refer frequently to an FPGA-style pipeline, the invention is not limited to FPGA implementation.

Referring to FIG. 4, an accelerator pipeline 400 may include an input register 402, a logarithm or exponentiation stage 404, an exponent-scale stage 406, a reconstruction stage 408, an add-one stage 410, a reciprocal stage 412, a sign inversion stage 414, and an output register 416. In one embodiment, the accelerator pipeline 400 is configured to evaluate the relation:

w(a)=−1/(1+a\hat{ }( 1/12))

for a supplied scale-factor input a. In some embodiments, the accelerator pipeline 400 is arranged as a synchronous pipeline in which intermediate values propagate stage-by-stage on clock cycles. In other embodiments, the accelerator pipeline 400 may be partially pipelined, deeply pipelined, iteratively reused, microcoded, or otherwise scheduled according to implementation constraints. In still other embodiments, the stages shown in FIG. 4 may be combined, subdivided, reordered, or selectively bypassed while preserving functional equivalence.

In some embodiments, a scale-factor input value is loaded into the input register 402. The input register 402 may receive values from the compute service 106, from the compute core 308, from a local memory interface, from a DMA engine, from a scheduler-linked interface, from a PCIe or similar host interface, or from another local or networked control path. In some embodiments, the input register 402 stores a scalar input value. In some embodiments, the input register 402 may instead store multiple queued values, vector lanes, batched values, or stream elements. In certain embodiments, the input register 402 may also receive associated metadata, such as a request identifier, a precision mode, a batch index, a valid-bit indicator, or a control flag indicating whether only w(a) or additional quantities are to be computed.

In some embodiments, the logarithm or exponentiation stage 404 begins a computation that ultimately produces the value a\hat{ }( 1/12). In one implementation, the logarithm or exponentiation stage 404 computes or approximates log(a) or log2(a) so that the exponentiation may be reformulated as a logarithm-plus-reconstruction problem. In another implementation, the logarithm or exponentiation stage 404 may use a direct power-function approximation without an explicit logarithm. In some embodiments, the stage 404 may employ a lookup table, segmented approximation, polynomial approximation, rational approximation, table-interpolation method, CORDIC-like routine, piecewise-linear approximation, or another deterministic numerical strategy suitable for hardware realization. In certain embodiments, the stage 404 may include a normalization substage that scales the input into a preferred domain prior to approximation. In some embodiments, the exponent-scale stage 406 applies the fixed exponent relation. In one embodiment, the exponent-scale stage 406 multiplies an intermediate logarithmic or transformed quantity by 1/12. In some embodiments, the factor 1/12is represented as a fixed constant in fixed-point or floating-point form. In some embodiments, the exponent-scale stage 406 includes one or more multipliers, shift-and-add structures, constant-coefficient multiply logic, DSP slices, microcoded operations, or programmable arithmetic units. In certain embodiments, the exponent-scale stage 406 may also support a test mode or extension mode in which a different exponent or correction factor is temporarily injected for validation or experimental use, provided that the claimed embodiment still centers on the disclosed fixed operational exponent 1/12.

In some embodiments, the reconstruction stage 408 reconstructs an exponentiated value corresponding to a\hat{ }( 1/12) from the scaled intermediate. In a logarithm-domain implementation, the reconstruction stage 408 may compute an antilogarithm, exponential, or exponent reconstruction using a lookup structure, segmented approximation, polynomial evaluator, interpolation engine, or other deterministic function unit. In some embodiments, the reconstruction stage 408 may be optimized for a particular numeric domain, such as normalized positive inputs corresponding to expected cosmological scale-factor ranges. In some embodiments, the reconstruction stage 408 may produce one or more side outputs, such as an approximation error estimate, a range classification, or a normalization-exponent indicator, although such side outputs are optional.

In some embodiments, the add-one stage 410 receives the reconstructed value corresponding to a\hat{ }( 1/12) and computes the denominator term:

1+a\hat{ }( 1/12)

The add-one stage 410 may be implemented with one or more adders, accumulators, fused arithmetic blocks, or constant-injection units. In fixed-point embodiments, the add-one stage 410 may align fractional bits and integer bits so that the constant unity value is correctly represented in the selected numeric format. In floating-point embodiments, the add-one stage 410 may use a floating-point adder or fused arithmetic unit. In some embodiments, the add-one stage 410 may also detect unexpected numeric conditions, such as saturation or invalid intermediate values, and may forward a status flag along the pipeline.

In some embodiments, the reciprocal stage 412 computes the reciprocal of the denominator term, thereby producing:

1/(1+a\hat{ }( 1/12))

In some embodiments, the reciprocal stage 412 uses a Newton-Raphson iteration. In some embodiments, the reciprocal stage 412 uses a seed estimate obtained from a lookup table and then refines that estimate in one or more iterative cycles. In some embodiments, the reciprocal stage 412 uses a direct table-based reciprocal, a piecewise approximation, a division engine, a multiplicative inverse approximation, or another deterministic reciprocal mechanism. In embodiments prioritizing throughput, the reciprocal stage 412 may be pipelined so that a new input may be accepted before a prior reciprocal result has fully exited all internal substeps. In embodiments prioritizing area or power savings, the reciprocal stage 412 may be iteratively reused across multiple cycles.

In some embodiments, the sign inversion stage 414 applies a negative sign to the reciprocal output to produce the final equation-of-state value:

w(a)=−1/(1+a\hat{ }( 1/12))

In many embodiments, the sign inversion stage 414 is comparatively simple and may be implemented as a sign-bit operation, a two's-complement transform, a negation unit, or a format-aware arithmetic inversion. In some embodiments, the sign inversion stage 414 may additionally forward or combine validity and exception flags generated by earlier stages. In some embodiments, the sign inversion stage 414 may be omitted where an earlier stage or formatting stage is configured to generate the signed output directly, but the functional operation of producing the negative reciprocal remains part of the disclosed computation path.

In some embodiments, the output register 416 stores the resulting equation-of-state value for transfer to another system component. In some embodiments, the output register 416 may store only w(a). In some embodiments, the output register 416 may store w(a) together with one or more metadata values, including a batch index, request identifier, precision flag, validity flag, approximation status, or latency marker. In some embodiments, the output register 416 may forward the result directly to the compute service 106, to the compute core 308, to the datastore 110, to the scheduler or planning engine 104, or to another downstream hardware or software consumer.

In some embodiments, the accelerator pipeline 400 may be configured to compute additional quantities beyond w(a). For example, a hardware embodiment may include optional logic for derivative evaluation corresponding to the derivative evaluator 208, such that dw/da may be computed in whole or in part on the accelerator. In some embodiments, the accelerator may additionally assist in expansion-history evaluation, table lookup for distance calculations, interpolation of stored kernel values, or repeated subcomputations used by the distance and observable calculator 212. In other embodiments, the accelerator pipeline 400 is limited to equation-of-state evaluation, while derived-quantity computation remains in software. Both arrangements are contemplated.

In some embodiments, arithmetic within the accelerator subsystem 108 may be fixed-point. Fixed-point embodiments can be advantageous in certain deployments because they may reduce logic area, lower power consumption, simplify timing closure, or increase throughput relative to higher-overhead floating-point implementations. In some embodiments, fixed-point values may be represented with signed or unsigned formats including integer and fractional fields selected according to the expected operational range of scale-factor inputs and resulting outputs. In one embodiment, the output range of w(a) over a selected domain may assist in choosing the number of integer bits and fractional bits used at the output of the sign inversion stage 414. In some embodiments, intermediate stages such as the logarithm or exponentiation stage 404, exponent-scale stage 406, or reconstruction stage 408 may use wider internal precision than the output stage in order to reduce accumulated error.

In some embodiments, arithmetic within the accelerator subsystem 108 may instead be floating-point. Floating-point embodiments may be useful where broad numeric dynamic range, simplified interoperability with software libraries, or reuse of existing floating-point hardware blocks is desired. In some embodiments, the accelerator may employ FP16, BF16, FP32, FP64, custom floating-point formats, or mixed floating-point formats. In mixed-precision embodiments, different stages of the accelerator pipeline 400 may use different precisions, such as using a higher precision in the reconstruction stage 408 or reciprocal stage 412 while using a lower precision in the input register 402 and output register 416. The invention is not limited to a single arithmetic representation.

In some embodiments, approximation quality and numerical error may be managed explicitly within the accelerator subsystem 108. For example, the logarithm or exponentiation stage 404 and reconstruction stage 408 may be designed to satisfy a selected maximum approximation error across a defined input interval. In some embodiments, the reciprocal stage 412 may be configured to achieve a target reciprocal accuracy after a selected number of iterations. In some embodiments, the accelerator subsystem 108 may expose a selectable precision mode, approximation mode, or performance mode. In some embodiments, error estimates, residual values, or confidence indicators may be propagated alongside the main data path and may ultimately be returned to the software layer for optional reporting or validation.

In some embodiments, the accelerator subsystem 108 may include local memories, coefficient stores, configuration registers, and control logic in addition to the pipeline blocks expressly shown in FIG. 4. For example, local memory may store lookup tables, interpolation coefficients, reciprocal seeds, normalization constants, polynomial coefficients, test vectors, calibration data, or mode settings. Configuration registers may be used to set batch sizes, select numeric precision, enable or disable optional computation branches, select fallback behavior, or specify interface options. Control logic may coordinate host communication, DMA transfers, pipeline flushes, error handling, and batching. These implementation details may be incorporated without requiring separate figure numerals for every internal support block.

In some embodiments, the accelerator subsystem 108 is interfaced to the compute service 106 through a host interface such as PCIe, CXL, coherent interconnect, shared memory, local bus, Ethernet-attached device control, or another machine interface. In some embodiments, the compute service 106 invokes the accelerator subsystem 108 by sending input values or batches to the input register 402 or to an associated command queue, then later reading values from the output register 416 or from an associated output buffer. In some embodiments, the interface may be interrupt-driven. In some embodiments, the interface may be polling-based. In some embodiments, DMA transfers may be used for high-throughput operation. In some embodiments, the accelerator subsystem 108 may appear to the software stack as a local device. In other embodiments, it may be exposed as a shared networked accelerator resource.

In some embodiments, throughput is increased by pipelining and by choosing an initiation interval that allows new inputs to enter the accelerator pipeline 400 at regular intervals. In some embodiments, once the pipeline is filled, new scale-factor inputs may be accepted every clock cycle or every selected number of clock cycles. In some embodiments, this enables high-rate equation-of-state evaluation for arrays of scale factors, redshift-bin studies, scheduler-candidate scoring, or repeated forecast computation. In some embodiments, throughput may further be increased by duplicating all or part of the pipeline, by instantiating multiple lanes, by using vectorized input registers, or by deploying multiple accelerator devices in parallel.

In some embodiments, power efficiency is a design consideration. Fixed-point implementations, carefully selected lookup-table strategies, reduced-iteration reciprocal stages, lower-frequency parallel lanes, or other architectural choices may reduce power draw relative to a less optimized implementation. This can be beneficial in observatory or edge deployments, including the offline or on-prem deployment module 612 of FIG. 6, where local power budgets, cooling budgets, or remote-site constraints may matter. In some embodiments, an accelerator may be deployed in a field unit, observatory rack, low-power edge appliance, or transportable analysis station.

In some embodiments, the accelerator subsystem 108 may be incorporated into the integration workflow 500 shown in FIG. 5. For example, the distance query module 508 or scoring engine 510 may request repeated evaluations of w(a) or other derived subquantities for many candidate targets or planning scenarios. In a hardware-assisted embodiment, those repeated evaluations may be offloaded to the accelerator subsystem 108, thereby reducing latency or host-processor workload. In some embodiments, the optimizer 512 may iterate over many observational configurations while relying on accelerator-generated values. In mission-design workflows, batches of redshift-bin computations may likewise be accelerated.

In some embodiments, the accelerator subsystem 108 may support fallback and redundancy modes. For example, if a hardware error, unavailable device, unsupported precision mode, or configuration issue prevents hardware execution, the compute core 308 may perform the same computation in software. In some embodiments, the system may compare hardware and software results on selected requests for validation, calibration, or regression testing. In some embodiments, a hardware self-test mode may apply known scale-factor inputs and compare generated outputs with stored reference values. Such a mode can be useful during manufacturing test, deployment acceptance, observatory maintenance, or field diagnostics.

In some embodiments, the accelerator subsystem 108 may be implemented not only as an FPGA but also as an ASIC. In an ASIC embodiment, the functions of the logarithm or exponentiation stage 404, exponent-scale stage 406, reconstruction stage 408, add-one stage 410, reciprocal stage 412, and sign inversion stage 414 may be embodied in dedicated logic blocks fabricated on an integrated circuit. An ASIC implementation may be advantageous for production deployment where power, size, latency, or high-volume reproducibility are especially important. In some embodiments, the same mathematical core may also be realized in GPU kernels or DSP pipelines, where the named stages correspond functionally rather than physically to separate blocks.

Accordingly, the disclosed hardware accelerator embodiments provide broad written-description support for dedicated, semi-dedicated, and mixed hardware realizations of the deterministic equation-of-state framework. These embodiments cover fixed-point and floating-point realizations, pipelined and iterative architectures, local and remote accelerator coupling, stand-alone and software-cooperative execution, and integration into both service and observatory planning systems, all while remaining centered on evaluation of the disclosed equation-of-state relation and associated derived quantities.

In some embodiments, the disclosed deterministic dark-energy forecast framework is integrated into operational scientific workflows rather than being used solely as a stand-alone mathematical evaluator. As shown in FIG. 1, the dark-energy forecast system 100 may interact with a scheduler or planning engine 104, a compute service 106, an accelerator subsystem 108, a datastore 110, and an observatory or mission environment 114. As further shown in FIG. 5, an integration workflow 500 may include a candidate input generator 502, a redshift or target estimator 504, a brightness or observable predictor 506, a distance query module 508, a scoring engine 510, an optimizer 512, a selection output 514, and an observatory or mission controller 516. These structures may be used in one or more practical embodiments including survey scheduling, exposure planning, mission-design trade studies, observational discrimination studies, transient follow-up planning, local observatory operation, and educational or simulation workflows.

In some embodiments, the integration workflow 500 is used in a survey scheduler context. For example, the candidate input generator 502 may generate a set of candidate pointings, targets, field visits, cadence options, observation windows, or survey tiles for evaluation. In some embodiments, the redshift or target estimator 504 may associate one or more estimated source redshifts, redshift distributions, scale-factor equivalents, target-class identifiers, or observational-state parameters with each candidate. In some embodiments, the brightness or observable predictor 506 may compute or estimate one or more expected observables for each candidate, such as expected source brightness, signal-to-noise ratio, distance-dependent flux behavior, redshift reach, cosmological leverage, or another planning-relevant quantity. In some embodiments, the brightness or observable predictor 506 may call the compute service 106 directly or may use outputs already returned from the distance query module 508.

In some embodiments, the distance query module 508 requests one or more values derived from the disclosed equation-of-state framework. By way of example, the distance query module 508 may request evaluation of w(a), dw/da, E(a), a comoving distance, a luminosity distance, an angular-diameter distance, a distance modulus, a volume distance, or another derived observable associated with one or more target redshifts or scale factors. In some embodiments, the distance query module 508 may submit these requests to the endpoint interface 302 of the service architecture 300. In other embodiments, the distance query module 508 may call a local library implementation, may retrieve precomputed values from the datastore 110, or may dispatch repeated evaluations to the accelerator subsystem 108. In some embodiments, the distance query module 508 may operate in batch mode so that multiple candidate observations may be evaluated together.

In some embodiments, the scoring engine 510 uses one or more outputs from the distance query module 508 and the brightness or observable predictor 506 to assign a score to each candidate. A score may be based on any combination of factors, including expected cosmological leverage, expected brightness, expected redshift coverage, expected distance uncertainty, expected signal-to-noise ratio, expected discrimination between the disclosed framework and another cosmological model, time cost, instrument constraints, weather constraints, observability constraints, mission-priority weights, or combinations thereof. In some embodiments, the scoring engine 510 may assign a scalar score. In some embodiments, the scoring engine 510 may produce a multi-objective score vector or a ranked list. In some embodiments, the scoring engine 510 may use deterministic rules, weighted formulas, lookup policies, optimization cost functions, or machine-assisted ranking logic, provided that one or more values derived from the disclosed equation-of-state framework are incorporated into the assessment.

In some embodiments, the optimizer 512 selects one or more preferred candidates based on outputs of the scoring engine 510. In some embodiments, the optimizer 512 may determine an exposure time, cadence, follow-up priority, field ordering, mission configuration, or redshift-bin allocation. In some embodiments, the optimizer 512 may operate greedily, iteratively, globally, or under constraint-based optimization. In some embodiments, the optimizer 512 may optimize a single observational cycle. In other embodiments, the optimizer 512 may optimize a full-night plan, a multi-night cadence plan, a survey-season plan, or a mission-design parameter set. In some embodiments, outputs of the optimizer 512 are transmitted through the selection output 514 to the observatory or mission controller 516 for execution, archival, user review, or further simulation.

In some embodiments, the integration workflow 500 is used for exposure planning. For example, a candidate source population or target field may be associated with one or more redshift estimates at the redshift or target estimator 504, and the distance query module 508 may compute a luminosity distance or distance modulus for those redshifts. The brightness or observable predictor 506 may use those outputs to estimate expected apparent brightness, flux, exposure requirements, or limiting detectability. In some embodiments, the scoring engine 510 and optimizer 512 may then select an exposure time or observing strategy that maximizes expected utility under a time budget, instrument constraint, or scheduling constraint. In some embodiments, repeated exposure computations over a large candidate set may be accelerated through the accelerator subsystem 108.

In some embodiments, the integration workflow 500 is used in a mission-design context. For example, the candidate input generator 502 may generate candidate mission architectures, redshift-bin allocations, instrument configurations, survey footprints, or cadence strategies. The redshift or target estimator 504 may associate forecast redshift distributions or population assumptions with each architecture. The distance query module 508 may request distance-related observables and expansion-history quantities derived from the disclosed model over one or more redshift intervals. The scoring engine 510 may then assess each candidate configuration according to expected science return, parameter-discrimination power, target coverage, instrument efficiency, forecast sensitivity, or another mission-relevant objective. In some embodiments, the optimizer 512 may select a preferred mission configuration or may generate a Pareto frontier of acceptable configurations. In some embodiments, the mission controller 516 may be a planning console, simulation platform, or report-generation tool rather than a real-time hardware controller.

In some embodiments, the integration workflow 500 is used for cosmological discrimination or trade-study analysis. For example, the model-comparison module 614 of FIG. 6 may compare outputs from the disclosed framework with outputs from one or more alternative cosmological models over common redshift bins or scale-factor samples. In some embodiments, the distance query module 508 may compute predicted observables under the disclosed equation-of-state relation, while one or more comparison engines compute corresponding observables for a constant-w model, a fitted w0/wa model, or another reference model. The scoring engine 510 may then assess which observational settings maximize the expected distinguishability between models. In some embodiments, the optimizer 512 may therefore choose an observing schedule, mission configuration, or target set designed to improve discrimination power.

In some embodiments, the disclosed framework is used in an observatory embodiment associated with the observatory or mission environment 114. In such an embodiment, the compute service 106 and optionally the accelerator subsystem 108 may be deployed locally at an observatory, either in a control-room workstation, a rack-mounted compute appliance, an embedded science processor, or another local scientific-compute unit. In some embodiments, the offline or on-prem deployment module 612 of FIG. 6 may package the disclosed software and optional accelerator logic for operation under constrained network conditions. In some embodiments, a local deployment reduces dependence on remote connectivity and may be beneficial at remote or bandwidth-limited sites. In some embodiments, locally generated values of w(a), distance, or derived observables may be fed directly into an observatory scheduling system or control console through the observatory or mission controller 516.

In some embodiments, the disclosed framework is used in a transient-alert embodiment. For example, the transient-alert module 610 of FIG. 6 may receive or process an alert associated with a supernova candidate, a standard-siren event, a follow-up target, or another transient event. In some embodiments, the redshift or target estimator 504 may obtain an estimated redshift or scale-factor equivalent for the event, and the distance query module 508 may compute a distance-related quantity or observable forecast using the disclosed framework. In some embodiments, the brightness or observable predictor 506 may estimate expected brightness evolution or follow-up value, and the scoring engine 510 may determine whether the event should be prioritized for observation. In some embodiments, this permits the disclosed deterministic framework to participate in real-time or near-real-time event triage.

In some embodiments, the standard-siren module 608 of FIG. 6 is used to adapt the disclosed framework for gravitational-wave-associated workflows. In one example, a counterpart redshift or inferred scale factor may be provided to the compute service 106, and one or more distance-related quantities derived from the disclosed equation-of-state framework may be used in event analysis, comparison, or forecasting. In some embodiments, outputs may be compared with independently inferred distances or may be used for observational planning. The invention is not limited to a particular standard-siren workflow and may be used in planning, simulation, comparison, or post-detection analysis contexts.

In some embodiments, the perturbation module 602, neutrino-mass module 604, or modified-gravity coupling module 606 may augment the integration workflow 500 without changing the core disclosed equation-of-state relation. For example, a mission study may evaluate the disclosed w(a) relation together with one or more perturbative or neutrino-related corrections to a derived observable. In some embodiments, a modified-gravity coupling module 606 may be used to generate alternative growth or structure-related forecasts that are combined with the disclosed background expansion relation. These extension modules are optional and may be omitted in embodiments directed only to the core equation-of-state evaluation and associated distance calculations. Their inclusion in the original filing, however, supports broader future claim strategies and reduces pressure for later continuation-in-part practice.

In some embodiments, the education or visualization module 616 presents outputs of the disclosed framework in a graphical, tabular, or interactive form. For example, a user may provide one or more scale factors or redshifts and may receive plotted values of w(a), dw/da, E(a), distance curves, or comparison plots against one or more other models. In some embodiments, this module supports classroom, outreach, demonstration, or software-validation use. In some embodiments, the same visualization functionality may be integrated into an operator dashboard associated with the client device 102 or with the observatory or mission controller 516.

In some embodiments, the datastore 110 stores operational data associated with the integration workflow 500. Such data may include target lists, candidate schedules, redshift catalogs, precomputed model outputs, cached distance values, optimization histories, benchmark comparisons, observation logs, mission-study grids, transient-alert histories, standard-siren event tables, or visualization assets. In some embodiments, storing such data reduces repeated computation for frequently queried inputs. In some embodiments, the datastore 110 also supports reproducibility by retaining inputs, outputs, timing data, precision modes, and comparison results for later review or audit.

In some embodiments, the disclosed framework is integrated into a larger automated planning environment. For example, the scheduler or planning engine 104 may repeatedly invoke the compute service 106 as new observational conditions arrive, as additional targets are discovered, as mission assumptions are updated, or as priority weights change. In some embodiments, the integration workflow 500 therefore operates continuously or iteratively rather than as a one-time calculation. In some embodiments, batch requests handled through the batch dispatcher 310 and optionally accelerated by the accelerator subsystem 108 may permit the system 100 to evaluate large candidate sets efficiently enough for real-time or near-real-time decision support.

In some embodiments, the disclosed framework may be used in a comparison-only embodiment, a planning-only embodiment, an execution-control embodiment, or a simulation embodiment. In a comparison-only embodiment, outputs are used for analysis or reporting but not for controlling a live instrument. In a planning-only embodiment, outputs inform a human decision-maker who manually chooses a schedule or configuration. In an execution-control embodiment, one or more selected outputs from the optimizer 512 are passed directly to the observatory or mission controller 516 for automated execution. In a simulation embodiment, the entire workflow may operate on hypothetical or forecast inputs without controlling a real instrument. All such modes are contemplated.

In some embodiments, the disclosed integration pathways provide practical advantages relative to workflows that rely on repeated fitting of free equation-of-state parameters. Because the disclosed framework may deterministically evaluate w(a) and associated derived quantities for a given input set, the integration workflow 500 can avoid at least some of the computational overhead associated with model-family sweeps over shape parameters. This may be beneficial in candidate scoring, large-grid mission studies, repeated exposure forecasts, edge deployments, or hardware-accelerated planning loops. These practical benefits arise from implementation choice and workflow design and need not be framed as limitations on claim scope.

Accordingly, the disclosed scheduler, mission-design, observatory, and practical integration embodiments provide support for using the deterministic equation-of-state framework in live, simulated, local, remote, batch, and real-time planning environments. These embodiments tie the core mathematical relation to concrete operational uses and support claims directed not only to computation itself but also to its application in scientific and engineering decision systems. In some embodiments, the disclosed deterministic dark-energy forecast framework is accompanied by validation, verification, and benchmarking procedures that support confidence in mathematical correctness, computational robustness, implementation performance, and practical utility. Such procedures may be used during development, deployment, observatory acceptance, mission-study preparation, service qualification, hardware qualification, regression testing, or later maintenance. As noted above, the system architecture 100 of FIG. 1 may include a compute service 106, an accelerator subsystem 108, and a datastore 110, while the computation flow 200 of FIG. 2 may include a validation layer 216 coupled to the equation-of-state evaluator 206, derivative evaluator 208, expansion-history evaluator 210, distance and observable calculator 212, and output generator 214. In some embodiments, the validation layer 216 performs mathematical checks, numerical checks, implementation checks, benchmark comparisons, and consistency checks across one or more execution modes.

In some embodiments, mathematical validation begins with direct properties of the disclosed equation-of-state relation:

w(a)=−1/(1+a\hat{ }( 1/12))

For example, the validation layer 216 may confirm that, for positive values of a, the equation-of-state output remains negative. In some embodiments, the validation layer 216 may confirm that the present-day value satisfies w(1)=−½within a selected tolerance. In some embodiments, the validation layer 216 may check that w(a) remains bounded over an operational interval, such as 0<a<=1, according to −1<w(a)<=−½. In some embodiments, the validation layer 216 may verify monotonic behavior over a selected input grid, including confirming that the computed output becomes less negative as scale factor increases. In some embodiments, the validation layer 216 may also confirm phantom exclusion by checking that w(a)>−1 throughout a defined test interval. These checks may be performed analytically, numerically, symbolically, by interval methods, by regression against reference values, or by combinations thereof.

In some embodiments, derivative validation is also performed. For example, the derivative evaluator 208 may compute:

dw/da=( 1/12)*a\hat{ }(( 1/12)−1)/(1+a\hat{ }( 1/12))\hat{ }2

and the validation layer 216 may compare computed derivative outputs against symbolic references, finite-difference approximations, regression tables, or stored acceptance values. In some embodiments, derivative validation may be performed at selected scale-factor values, over predefined intervals, or across randomized test inputs. In some embodiments, derivative validation may be used to qualify a software build, a compiled kernel, a hardware implementation, or a surrogate evaluator constrained to the same disclosed relation.

In some embodiments, validation extends to the expansion-history evaluator 210 and the distance and observable calculator 212. For example, the validation layer 216 may verify that the expansion-history evaluator 210 produces expected outputs for selected inputs H0, Ω_m, Ω_DE, and a or z. In some embodiments, the distance and observable calculator 212 may be validated against known limiting cases, against stored baseline values, or against an independently implemented reference solver. In some embodiments, validation of the distance and observable calculator 212 may include checks on comoving distance, luminosity distance, angular-diameter distance, distance modulus, or other derived observables at representative redshift bins or scale-factor intervals. In some embodiments, the datastore 110 may retain reference datasets or baseline outputs for use in repeated validation and regression testing.

In some embodiments, formal or semi-formal verification may be employed. By way of example, mathematical support for the disclosed framework may include formalization or proof-style validation of one or more properties such as fixed exponent support, positivity of the exponent 1/12, negativity of w(a) for positive a, boundedness of w(a) over a selected interval, present-day value, monotonicity, or phantom exclusion. In some embodiments, such formalization may be implemented using symbolic proof systems, theorem-proving tools, interval-verification engines, or consistency-checking frameworks. In some embodiments, these formal procedures may be used to validate the mathematical relation itself. In other embodiments, they may be used to validate software or hardware implementations relative to the disclosed relation. The invention is not limited to any particular formal toolchain.

In some embodiments, software-implementation validation is performed by the compute service 106, the compute core 308, the batch dispatcher 310, the response formatter 312, or associated test infrastructure. For example, a software-validation suite may supply selected inputs through the parameter parser 304 and input validator 306, then compare outputs of the compute core 308 against stored references. In some embodiments, software validation may include scalar tests, vector tests, batch tests, randomized tests, endpoint tests, error-condition tests, regression tests, and precision-mode tests. In some embodiments, service-level validation may further include tests for malformed requests, boundary-domain inputs, authentication failures, timeout conditions, concurrency behavior, and batch-order preservation.

In some embodiments, hardware validation is performed for the accelerator subsystem 108 and the accelerator pipeline 400 shown in FIG. 4. For example, a hardware self-test or acceptance routine may provide selected scale-factor values to the input register 402, observe outputs at the output register 416, and compare the outputs against software-generated references. In some embodiments, validation may be performed for each stage of the pipeline, including the logarithm or exponentiation stage 404, exponent-scale stage 406, reconstruction stage 408, add-one stage 410, reciprocal stage 412, and sign inversion stage 414. In some embodiments, hardware validation may also assess pipeline latency, throughput, numerical error, range handling, saturation behavior, exception handling, and host-interface behavior. In some embodiments, validation may compare hardware and software outputs over a large test corpus to ensure that hardware results remain within selected tolerances.

In some embodiments, benchmark procedures are used to characterize implementation performance. Such procedures are distinct from mathematical validation and may be used to assess operational suitability rather than mathematical truth. In some embodiments, engineering benchmarking may include latency measurements for scalar calls handled by the endpoint interface 302, throughput measurements for batch workloads handled by the batch dispatcher 310, power measurements for the accelerator subsystem 108, memory-footprint measurements, scaling measurements across multiple service instances, or observatory workflow timing measurements. In some embodiments, benchmarks may be performed for one or more precision modes, hardware configurations, batch sizes, deployment environments, or workload types. In some embodiments, benchmark outputs may be stored in the datastore 110 for comparison across software versions, hardware revisions, or deployment sites.

In some embodiments, observational benchmarking is also performed. By way of example, the disclosed framework may be used to generate one or more forecast or distance-related quantities for comparison with supernova datasets, baryon acoustic oscillation datasets, cosmic microwave background distance data, or future-survey discrimination analyses. In some embodiments, such benchmarking does not redefine the invention but demonstrates how the disclosed deterministic framework may be assessed against observational reference material. In some embodiments, supernova benchmarking may involve comparing model-derived distance moduli against calibrated supernova data. In some embodiments, baryon acoustic oscillation benchmarking may involve comparing derived distance measures against observed redshift-bin metrics. In some embodiments, cosmic microwave background benchmarking may involve comparing model-derived distance-related quantities at high redshift against accepted reference values or baseline cosmological calculations. In some embodiments, future-survey benchmarking may be used to assess forecast distinguishability between the disclosed framework and one or more reference cosmological models.

In some embodiments, the specification distinguishes clearly among mathematical properties, observational benchmarks, and engineering benchmarks. A mathematical property may be a property of the disclosed functional relation itself, such as negativity or monotonicity. An observational benchmark may be a comparison between outputs of the disclosed framework and one or more empirical datasets or forecast datasets. An engineering benchmark may be a latency, throughput, power, or deployment-performance measurement for a particular software or hardware implementation. This distinction is useful because a mathematical property may hold across embodiments, while benchmark results may vary with dataset, deployment context, numerical method, hardware selection, software revision, or operational settings. Accordingly, benchmark examples described herein are illustrative and need not be treated as claim limitations unless expressly recited.

In some embodiments, alternative computational embodiments are expressly supported in order to broaden written-description coverage and reduce the likelihood that later implementation refinements would require a continuation-in-part. For example, although some embodiments evaluate w(a) directly from the explicit relation, other embodiments may use lookup tables, piecewise approximations, interpolation structures, compiled kernels, symbolic evaluators, cached outputs, surrogate evaluators constrained to the same base relation, or hardware-resident approximation engines. Likewise, although some embodiments compute derivative or distance quantities on demand, other embodiments may rely on precomputed kernels, table-assisted quadrature, mixed software/hardware evaluation, or deferred execution workflows. All such variants are contemplated so long as they are grounded in the disclosed deterministic equation-of-state framework.

In some embodiments, alternative input representations are supported. For example, the parameter parser 304 may receive scale factor directly, may receive redshift and convert it to scale factor, may receive logarithmic representations, may receive reciprocal-scale representations, or may receive other mathematically corresponding variables from which the disclosed relation may be evaluated. In some embodiments, internally normalized variables may be used for hardware or software convenience. Such transformations do not depart from the disclosed framework.

In some embodiments, alternative deployment embodiments are supported. For example, the compute service 106 may be deployed as a local library, a workstation executable, a server process, a cloud-native microservice, a batch-processing service, a shared observatory appliance, or an embedded scientific-compute resource. In some embodiments, the accelerator subsystem 108 may be local, remote, integrated, removable, optional, or omitted entirely. In some embodiments, the offline or on-prem deployment module 612 may package a self-contained observatory implementation. In some embodiments, the education or visualization module 616 may provide a user-facing or teaching-oriented representation of the same underlying engine.

In some embodiments, alternative extension modules are supported. For example, the perturbation module 602 may add one or more perturbative corrections to derived quantities. The neutrino-mass module 604 may incorporate neutrino-related effects into expansion or distance calculations. The modified-gravity coupling module 606 may combine the disclosed equation-of-state framework with a separate gravity or growth framework. The standard-siren module 608 may adapt the disclosed framework for gravitational-wave-related planning or analysis. The transient-alert module 610 may support event-triggered observational triage. The model-comparison module 614 may compare the disclosed framework with one or more alternative cosmological models. The education or visualization module 616 may present outputs interactively. These extensions are optional and may be omitted in a core embodiment, but their inclusion in the original disclosure provides flexibility for later prosecution and claim development.

In some embodiments, alternative hardware embodiments are also contemplated beyond the specific pipeline shown in FIG. 4. For example, a GPU implementation may evaluate the disclosed relation over large arrays of inputs using kernel execution. A DSP embodiment may use fixed-point vector operations. An ASIC embodiment may hardwire the disclosed arithmetic flow. A vector-CPU embodiment may use SIMD instructions. A mixed hardware/software embodiment may offload only exponentiation or reciprocal operations while retaining integration or response logic in software. In some embodiments, a multi-accelerator deployment may partition work across several devices. Such alternatives are expressly contemplated as part of the disclosed implementation space.

In some embodiments, alternative validation and benchmarking pathways are also contemplated. For example, one deployment may use interval arithmetic and symbolic checks, while another relies on regression tables and software/hardware cross-comparison. One observatory may benchmark latency under low-bandwidth local conditions, while a cloud deployment may benchmark throughput under large batch loads. One mission-analysis workflow may emphasize discrimination metrics, while another emphasizes deterministic reproducibility or hardware efficiency. These differences do not alter the underlying disclosed invention.

In some embodiments, the disclosed framework may be practiced in a minimal embodiment consisting essentially of receiving a scale factor and returning w(a). In some embodiments, the disclosed framework may be practiced in an expanded embodiment including derivative computation, expansion-history computation, distance computation, service exposure, hardware acceleration, scheduling integration, mission-design integration, and optional extension modules. Between those two ends of the spectrum, numerous intermediate embodiments are possible, and the present disclosure is intended to support combinations and subcombinations of the described elements.

Accordingly, the validation, verification, benchmarking, and alternative-embodiment discussion provided herein is intended both to support implementation confidence and to expand written-description coverage. By clearly separating mathematical properties from observational and engineering benchmarks, and by expressly disclosing optional computational, deployment, hardware, and extension variations, the specification is structured to support examiner review and prosecution while reducing the need for later continuation-in-part practice merely to capture foreseeable implementation refinements.

1. A computer-implemented method for evaluating a dark-energy equation of state, the method comprising:
receiving, by one or more processors, an input corresponding to a cosmological scale factor a;
computing, by the one or more processors, an equation-of-state value w by: (i) determining a\hat{ }( 1/12), (ii) computing 1+a\hat{ }( 1/12), (iii) computing a reciprocal of 1+a\hat{ }( 1/12), and (iv) applying a negative sign; and
outputting or storing the equation-of-state value w,
wherein the equation-of-state value corresponds to w(a) 32 −1/(1+a\hat{ }( 1/12)) and is computed without fitting free equation-of-state shape parameters.

2. The method of claim 1, wherein the method further comprises validating that the received cosmological scale factor a satisfies a >0, and returning an error indication when a≤0.

3. The method of claim 1, wherein receiving the input comprises receiving a redshift value z and determining the cosmological scale factor according to a=1/(1+z).

4. The method of claim 1, further comprising evaluating a derivative of the dark-energy equation of state with respect to scale factor according to:
dw/da=( 1/12)·a\hat{ }(( 1/12)−1)/(1+a\hat{ }( 1/12))\hat{ }2.

5. The method of claim 1, further comprising computing a dimensionless Hubble function E(a) based at least in part on the evaluated dark-energy equation of state.

6. The method of claim 5, wherein computing the dimensionless Hubble function comprises computing E(a) using a matter-density term proportional to a\hat{ }(−3) and a dark-energy term determined using an exponential of an integral over scale factor from 1 to a of ((1+w(u))/u) du.

7. The method of claim 1, further comprising computing a cosmological distance quantity based at least in part on the evaluated dark-energy equation of state.

8. The method of claim 7, wherein the cosmological distance quantity comprises at least one of a comoving distance, a luminosity distance, an angular-diameter distance, a distance modulus, a volume distance, a lookback-time quantity, or an age-related quantity.

9. The method of claim 1, wherein evaluating the dark-energy equation of state comprises computing a\hat{ }( 1/12), adding unity to obtain 1+a\hat{ }( 1/12), computing a reciprocal of 1+a\hat{ }( 1/12), and applying a negative sign.

10. The method of claim 7, wherein computing the cosmological distance quantity comprises selecting, using an input parameter, a distance-evaluation mode including at least one of: (i) numerical quadrature with adaptive step sizing, (ii) lookup-table evaluation with interpolation, or (iii) a closed-form or semi-closed-form kernel.

11. A system for evaluating a dark-energy equation of state, the system comprising:
one or more processors;
a memory storing instructions; and
a service interface configured to receive an input corresponding to a cosmological scale factor a,
wherein execution of the instructions by the one or more processors causes the system to:
evaluate the dark-energy equation of state according to w(a)=−1/(1+a\hat{ }( 1/12)); and
output a value corresponding to w(a),
wherein the system is configured to evaluate the dark-energy equation of state without fitting free equation-of-state shape parameters.

12. The system of claim 11, wherein the service interface is network-accessible and is configured to receive requests from a remote client.

13. The system of claim 11, wherein the service interface is configured to expose at least one endpoint for equation-of-state evaluation, at least one endpoint for derivative evaluation, or at least one endpoint for distance evaluation.

14. The system of claim 11, further comprising an input validator configured to validate one or more received inputs before evaluation of the dark-energy equation of state, including validating that a received scale factor satisfies a >0, and generating a structured error response when the validation fails.

15. The system of claim 11, further comprising a batch dispatcher configured to distribute evaluation of the dark-energy equation of state for a plurality of inputs.

16. A hardware accelerator for evaluating a dark-energy equation of state, the hardware accelerator comprising:
an input register configured to receive an input corresponding to a cosmological scale factor a;
arithmetic circuitry configured to determine a\hat{ }( 1/12), determine 1+a\hat{ }( 1/12), compute a reciprocal of 1+a\hat{ }( 1/12), and apply a negative sign to produce w(a)=−1/(1+a\hat{ }( 1/12)); and
an output register configured to output the produced value of w(a).

17. The hardware accelerator of claim 16, wherein the arithmetic circuitry comprises a logarithm or exponentiation stage, an exponent-scale stage, a reconstruction stage, an add-one stage, a reciprocal stage, and a sign inversion stage.

18. The hardware accelerator of claim 16, wherein the hardware accelerator is configured to use fixed-point arithmetic for at least part of the evaluation.

19. A computer-implemented method for selecting an observational or mission-planning action, the method comprising:
generating, by one or more processors, a plurality of candidate observational or mission-planning inputs;
evaluating, for at least some of the plurality of candidate observational or mission-planning inputs, one or more quantities derived at least in part from a dark-energy equation of state according to w(a)=−1/(1+a\hat{ }( 1/12));
scoring the plurality of candidate observational or mission-planning inputs based at least in part on the one or more derived quantities; and
selecting at least one observational or mission-planning action based on the scoring.

20. The method of claim 19, wherein the selected observational or mission-planning action comprises a survey pointing, an exposure time, a cadence selection, a follow-up priority, a redshift-bin allocation, an instrument configuration, or a mission configuration.
